(19) United States
(12) Patent Application Publication
(10) Pub. No.: US 2014/0137447 A1
(43) Pub. Date: May 22, 2014

(54) Systems and Methods for Vehicle Advertising

(71) Applicant: Inbal Mama, Reseda, CA (US)

(72) Inventor: Inbal Mama, Reseda, CA (US)

(21) Appl. No.: 13/684,112

(22) Filed: Nov. 21, 2012

(51) Int. Cl. G09F 21/04

(52) U.S. Cl. CPC G09F 21/04; G09F 21/048
USPC 40/538

(57) ABSTRACT

Various embodiments provide an advertising apparatus for a vehicle, where the advertising apparatus comprises a dressing for the vehicle, and a fastener configured to couple to the dressing to the exterior features of the vehicle. The dressing may be configured to cause at least a portion of the vehicle to resemble a product when the dressing is coupled to the vehicle to cover at least a portion of an exterior body of the vehicle. Additionally, the fastener may be configured to couple the dressing to the vehicle such that the dressing covers the portion of the exterior body of the vehicle. For some embodiments, the advertising apparatus dresses some or all of the exterior body of the vehicle such that the vehicle's exterior appearance is altered to the likeness of some or all of a product, thereby enabling the vehicle to function as mobile advertisement for the product.

### BACKGROUND

1. Technical Field

The present invention(s) generally relate to advertising and, more particularly, advertising adapted for use with vehicles.

2. Description of Related Art

Various forms of advertising provide varying levels of benefit to product marketing. While some forms of advertising involve isolated and/or targeted exposure to the public (e.g., event-based advertising, such as product-related launch parties or product-sponsored charity events), some others can provide broad exposure to the public (e.g., billboard advertising, television or radio commercials, print advertisement in publications, etc.). For a given advertisement, its mode of advertisement, its uniqueness and/or creativity (e.g., in comparison to others of the same mode), and its placement (e.g., location of the given advertisement based on the mode and/or its context) can play key roles in its exposure level and its memorability (e.g., with respect to a target audience).

Generally, a given advertisement is more exposed and/or memorable when its selected mode of advertisement can facilitate wide exposure (e.g., billboards by roadways), when the advertisement is more unique/creative than other advertisements (e.g., contents of roadway billboards temporally change), and/or when the advertisement is better placed than others advertisements (e.g., a given billboard is placed more visibly in comparison to others nearby). Oftentimes, highly exposed and memorable advertisements greatly benefit the marketing efforts of the product(s) being advertised.

### SUMMARY

Various embodiments relate to advertising apparatuses configured for use with a vehicle. Some embodiments provide an advertising apparatus for a vehicle, where the advertising apparatus comprises a dressing for the vehicle, and a fastener configured to couple to the dressing to the exterior features of the vehicle. The dressing may be configured to cause at least a portion of the vehicle to resemble (e.g., visually resemble and/or physically resemble) a product when the dressing is coupled to the vehicle to cover at least a portion of an exterior body of the vehicle. Additionally, the fastener may be configured to couple the dressing to the vehicle such that the dressing covers the portion of the exterior body of the vehicle.

In accordance with some embodiments, when the advertising apparatus is used with a vehicle, the advertising apparatus dresses some or all of the exterior body of the vehicle such that the vehicle's exterior appearance is altered (e.g., permanently altered or temporarily altered) to the likeness of some or all of a product (e.g., the physical appearance of some or all of the product). In doing so, various embodiments can cause the vehicle to function as mobile advertisement for the product, whether the vehicle in motion (e.g., moving on a highway or freeway) or is stationary (e.g., parked or at traffic light). For some embodiments, the level of advertising exposure achieved by the advertising apparatus may depend on the vehicle's location, the vehicle's current state (e.g., moving or stationary), the nature of the alteration(s) applied to the vehicle's appearance by the advertising apparatus (e.g., advertising apparatus comprises moving elements or illuminated portions), how much of the vehicle's appearance is altered by the advertising apparatus, or how close in appearance the vehicle's appearance is to the product being resembled.

Particular embodiments may be compatible with self-propelled vehicles (e.g., cars, trucks, buses, rail-based vehicles, etc.) or non-self-propelled vehicles (trailers, rail cars, etc.). For example, the vehicle may be a tanker truck or a tanker trailer, and the advertising apparatus may be configured to cause the tanker portion (of the tanker truck or tanker trailer) to resemble an aluminum beverage can, a roll of candy, a battery, or a tube of toothpaste when the advertising apparatus is coupled to the vehicle to cover the tanker portion. Vehicles compatible with some embodiments can include ground-based vehicles and aerial vehicles.

The product being resembled may comprise product packaging, or product content. Accordingly, as used herein, the term “product” can refer to product packaging (e.g., a box containing software on a disc, a can that contains liquid such as motor oil or soda, or a wrapper containing candy), to product content (e.g., typically contained in the product packaging, such as the oil or soda typically stored in the container or the candy typically in the wrapper), or to some the combination of both (i.e., the product packaging and the product content). Generally, the product is one offered for sale (e.g., to a consumer), and may include consumables (food, beverages, personal care-related, healthcare-related), software, electronics, entertainment-related products (e.g., tickets to an event, music, movies, etc.), clothing, tools, parts (e.g., automotive parts), and the like. Product packaging may include containers (e.g., bottles, cans, bags, boxes, etc.) and wrappings (e.g., plastic or paper wrapper).

For various embodiments, the dressing may comprise a three-dimensional feature configured to resemble at least a portion of the product. For example, the outside-facing, exterior surface of the dressing may comprise a relief configured to resemble at least one of the physical features of the product. For some embodiments, the dressing may comprise a plastic overlay, a fabric sleeve, or a metal attachment. Additionally, for certain embodiments, the dressing may comprise a set of two or more dressing pieces that individually couple to the vehicle, possibly in an overlapping manner). As an alternative to using dressings, various embodiments may paint a surface and/or etch a surface of the target vehicle such that at least some portion of the vehicle resembles (e.g., visually or physically) the product which it intends to advertise.

For some embodiments, the fastener may be further configured to removably couple the dressing to the exterior features of the vehicle. Depending on the embodiment, the fastener may comprise a magnet, an adhesive, a hook-and-loop fastener, a clip, a strap, a rope, a button, or the like. Generally, the fastener facilitates the coupling to the exterior body of the vehicle, or a surface on the interior of the vehicle.

As noted herein, the product resembled by the dressing may comprise product packaging and/or product content. Examples of product packaging include cans, boxes, bags, wrappers (e.g., paper, plastic, or metal-based), tubes, bottles, and the like. Where the product packaging is a can (e.g., aluminum beverage can, such as a soda can), the can may comprise a stay-on-tab opening mechanism or a pull-tab opening mechanism (e.g., like those found on the top side of an aluminum beverage can or a soup can) for opening the product packaging. Additionally, the product packaging resembled by the dressing may comprise an opening (i.e., the dressing resembles the product packaging with an opening). For example, for an aluminum beverage can, the opening may be the one created in the top side of the aluminum beverage can by use of the stay-on-tab. In another example involving a tube, the opening for the tube may be the one exposed when the cap (e.g., screw-on cap or pop-up cap) is removed from the top of the tube.

With respect product content and openings, the dressing may further resemble product content that is visible through the opening and/or product content that appears to be exiting the product packaging through the opening. For instance, where the dressing resembles a top side of an aluminum beverage can with an opening (e.g., created by the stay-on-tab mechanism), the dressing may further resemble product content of the aluminum beverage can (e.g., soda) existing from the aluminum beverage can opening (e.g., pouring out from the opening). Likewise, where the dressing resembles a top side of a tube of toothpaste with an opening (e.g., open tube cap), the dressing may further resemble the product content of the tube (e.g., toothpaste) exiting from the tube opening (e.g., oozing out of the open tube cap). Those skilled in the art will appreciate that for some embodiments, the dressing may resemble the product content alone (loaf of bread) devoid of any product packaging (e.g., plastic bread bag).

According to some embodiments, the dressing may comprise fabric, rigid, or semi-rigid material (e.g., fiberglass, plastic, or metal panel). For example, the dressing may in the form of a covering configured to cover a portion of the vehicle. Additionally, in some embodiments, the panel may comprise elements/features that enable the panel to illuminate (e.g., at night). For instance, the dressing may comprise an electroluminescent panel. Various embodiments may comprise an electronic lighting system configured to illuminate at least a portion of the dressing.

According to certain embodiments, a method is provided for use of an advertising apparatus, as described herein, with a vehicle.

In other embodiments, the dressing described herein may be applied (e.g., coupled) to a non-vehicle structure, such as a building, a building component (e.g., HVAC unit, etc.), telephone pole, tree, or mailbox. Depending on characteristics of the non-vehicle structure (e.g., size, shape, appearance, color, etc.), some or all of the structure may be covered by a dressing such that the dressing causes the structure to resemble the product. In another embodiment, the vehicle or portions of the vehicle may be formed to resemble the product or parts of the product.

Other features and aspects of various embodiments will become apparent from the following detailed description, taken in conjunction with the accompanying drawings, which illustrate, by way of example, the features of such embodiments.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various embodiments are described in detail with reference to the following figures. The drawings are provided for purposes of illustration only and merely depict some embodiments. These drawings shall not be considered limiting of the breadth, scope, or applicability of embodiments.

FIG. 1 depicts an exemplary advertising apparatus that causes a vehicle to resemble an aluminum beverage can in accordance with some embodiments.

FIG. 2 is a diagram illustrating how an exemplary advertising apparatus may be coupled to a vehicle in accordance with some embodiments.

FIG. 3 depicts an exemplary advertising apparatus that causes a vehicle to resemble an aluminum beverage can in accordance with some embodiments.

FIG. 4 depicts an exemplary advertising apparatus that causes a vehicle to resemble a roll of candy in accordance with some embodiments.

FIG. 5 depicts an exemplary advertising apparatus that causes a vehicle to resemble a battery in accordance with some embodiments.

### DETAILED DESCRIPTION

Various embodiments described herein can enable a vehicle to function as mobile advertising apparatus, particularly with respect to a given physical product. In accordance with certain embodiments, an advertising apparatus is provided for vehicles where the advertising apparatus is configured to dress-up the vehicle such that at least some portion of the vehicle resembles (e.g., visually or physically) the product which it intends to advertise. In particular, the advertising apparatus provided may be configured to (temporarily or permanently) couple to a target vehicle (e.g., the vehicle being dressed-up) such that the portions of the target vehicle at least visually resemble the product intending to be advertised. For example, the advertising apparatus may comprise a dressing configured to cause at least a portion of the vehicle to resemble a product when the dressing is coupled to the vehicle to cover at least a portion of an exterior body of the vehicle. Additionally, the advertising apparatus may further comprise a fastener configured to couple the dressing to the vehicle (e.g., couple in such a manner as to cause the dressing to cover the portion of the exterior body of the vehicle).

For some embodiments, the dressing may comprise a plastic overlay, a fabric sleeve, or a metal attachment. As an alternative to using dressings, various embodiments may paint a surface and/or etch a surface of the target vehicle such that at least some portion of the vehicle resembles (e.g., visually or physically) the product which it intends to advertise.

Generally, once the advertising apparatus is coupled to a vehicle, the intended audience for the advertising provided includes those observing the vehicle as it passes by or as they pass by it (e.g., while the vehicle is in motion or while the vehicle is stationary). Aspects of the advertising apparatus, such as the fasteners, may permit the advertising apparatus to retain its coupling with the vehicle regardless of whether the vehicle is in motion or at a standstill. Further, the advertising apparatus may comprise features that provide the dressing (and its features) with illumination and/or animation, thereby causing the advertising apparatus to attract the attention of more observers while the advertising apparatus is coupled to the target vehicle. For examples, the advertising apparatus may comprise an electrical lighting system that causes portions of the dressing (of the advertising apparatus) to illuminate and/or animate.

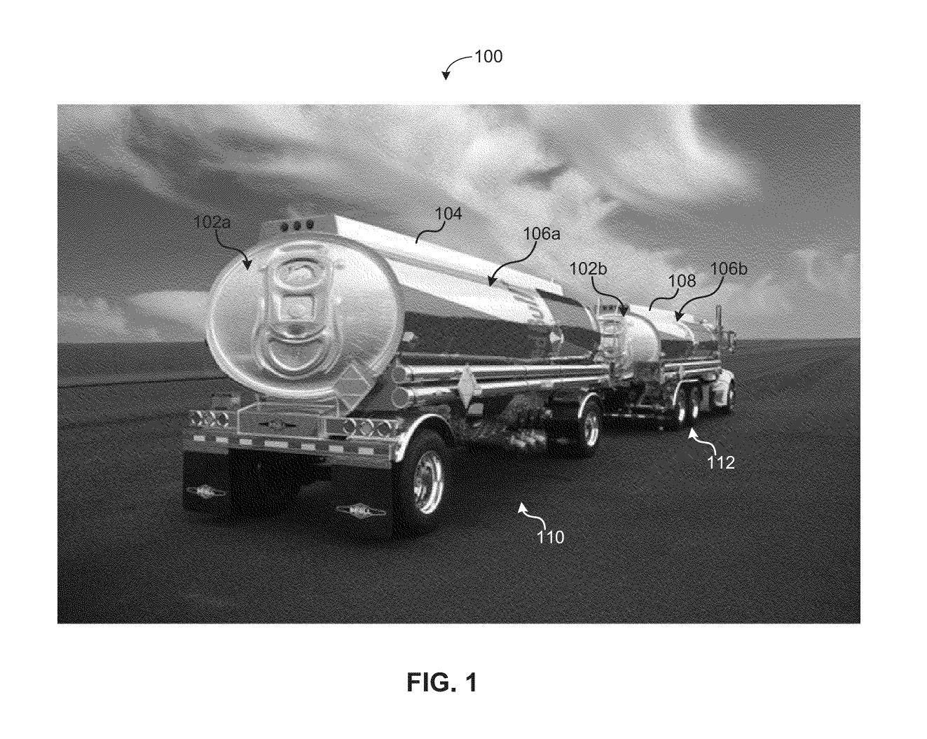

FIG. 1 depicts an exemplary advertising apparatus that causes a vehicle to resemble an aluminum beverage can in accordance with some embodiments. In particular, FIG. 1 depicts a tanker truck 100 (sometime referred herein as “vehicle 100”) comprising a tanker tractor 112, having a tanker portion 108, and a tanker trailer 110, having a tanker portion 104. As shown, the tanker truck 100 is equipped with an advertising apparatus that dresses up (exterior) sections of the tanker portions 108 and 104 to cause them to resemble a product, in this case aluminum beverage cans. The advertising apparatus shown comprises rear dressings 102a and 102b (hereafter, collectively referred to as “rear dressings 102”) coupled to portions of the vehicle 100 such that the rear dressings 102 respectively cover rear-facing sections of the tank portions 108 and 104. The advertising apparatus shown further comprises side dressings 106a and 106b (hereafter, collectively referred to as “side dressings 106”) coupled to portions of the vehicle 100 such that the side dressings 106 respectively cover side sections of the tanker portions 108 and 106. Though not shown in FIG. 1, those skilled in the art will appreciate that the advertising apparatus may comprise of further dressings (than what is shown) which may cover other sections of the tanker portions 108 and 104 (e.g., the front-facing sections, other side sections, top or bottom sections, or sections of the tanker portion's exterior surface area) or the vehicle 100, thereby dressing up those sections to further cause portions of the vehicle 100 to resemble aluminum beverage cans.

Those skilled in the art will appreciate that for some embodiments, the dressing (of the advertising apparatus) may comprise a set of two or more dressing pieces that individually couple to the vehicle 100, possibly in an overlapping manner. With respect to one another, the dressing pieces may vary in shape, size, color, lettering, and the amount of vehicle area covered (i.e., level of vehicle coverage). For instance, with respect to the tanker portions 108 and 104 of the vehicle 100, the dressing may comprise two or more dressing pieces, and the dressing once coupled to the vehicle 100, may result in the tanker portions 108 and 104 being wrapped by the dressing, possibly in their entirety. Ultimately, the dressing can be configured in any number of physical dimensions to cover various portions of the vehicle 100.

The rear dressings 102 and side dressings 106 may be coupled to the vehicle 100 by a number of different coupling methodologies including, for example, fasteners that comprise a magnet, an adhesive (e.g., glue), a hook-and-loop fastener (e.g., Velcro®), a clip, a strap, a rope, or a button. Depending on the embodiment, the coupling methodology utilized may couple the dressings 102 and/or 106 directly to the portions of the vehicle 100 that are being dressed-up (e.g., covered), or may couple the dressings 102 and/or 106 to physical features of the vehicle 100 (e.g., handles, hooks, frame, etc.), which may be adjacent to the portions of the vehicle 100 being covered. Those skilled in the art will appreciate that possible coupling points for dressings 102 and/or 106 can include those disposed on the exterior of the vehicle 100 (e.g., exterior handles, hooks, or loops) and those disposed on the interior of the vehicle (e.g., features in the passenger cabin or in a storage area of the vehicle 100).

For the dressings 102 and/or 106 to cause portions of the vehicle to resemble a product to be advertised, the dressings 102 and/or 106 may comprise visual features and/or physical features that cause the dressings 102 and/or 106 to cover or augment the physical appearance of select portions of the vehicle 100. Unless stated otherwise, the term “product” as understood herein can refer to product packaging, product content, or some combination thereof. In some instances, the “product” may be intangible (e.g., software or power) and stored on a suitable storage medium (e.g., computer readable medium for software, or one or a power cell/battery for power). Accordingly, the dressing for various embodiments may resemble such a suitable storage medium.

The visual and/or physical features utilized by the dressings 102 and/or 106 can include two-dimensional depictions of features of the product or three-dimensional structures (e.g., reliefs) that would cause portions of the vehicle 100 to resemble features of the product (when the dressings 102 and/or 106 are coupled to the vehicle 100). In some embodiments, the advertising apparatus may comprise dressings 102 and/or 106 that utilize a combination of two-dimensional depictions and three-dimensional structures to achieve the product resemblance. As noted herein, in accordance with various embodiments, the advertising apparatus may utilize the visual and/or physical features of the dressing to cause the vehicle 100 to resemble product packaging (e.g., a box containing software on a disc, a can that contains liquid such as motor oil or soda, or a wrapper containing candy), to resemble product content (e.g., typically contained in the product packaging, such as the oil or soda typically stored in the container or the candy typically in the wrapper), or to resemble some the combination of both (i.e., the product packaging and the product content). An example of the latter can include where the advertising apparatus causes the vehicle 100 to resemble product packaging (e.g., aluminum beverage can) with the (product) contents (in the product packaging) appearing visible through an opening in the product packaging or appearing as if it is exiting from an opening in the product packaging (e.g., soda pouring from an opening). Generally, various aspects of the vehicle's appearance contribute to the advertising apparatus causing the vehicle 100 to resemble a product. Some of those aspects can include the color of the vehicle (e.g., exterior paint color(s)), shape of physical features of the vehicle 100 (e.g., cylindrical shape of a tank of a tanker trailer can add to the resemblance of an aluminum beverage can), and orientation of physical features.

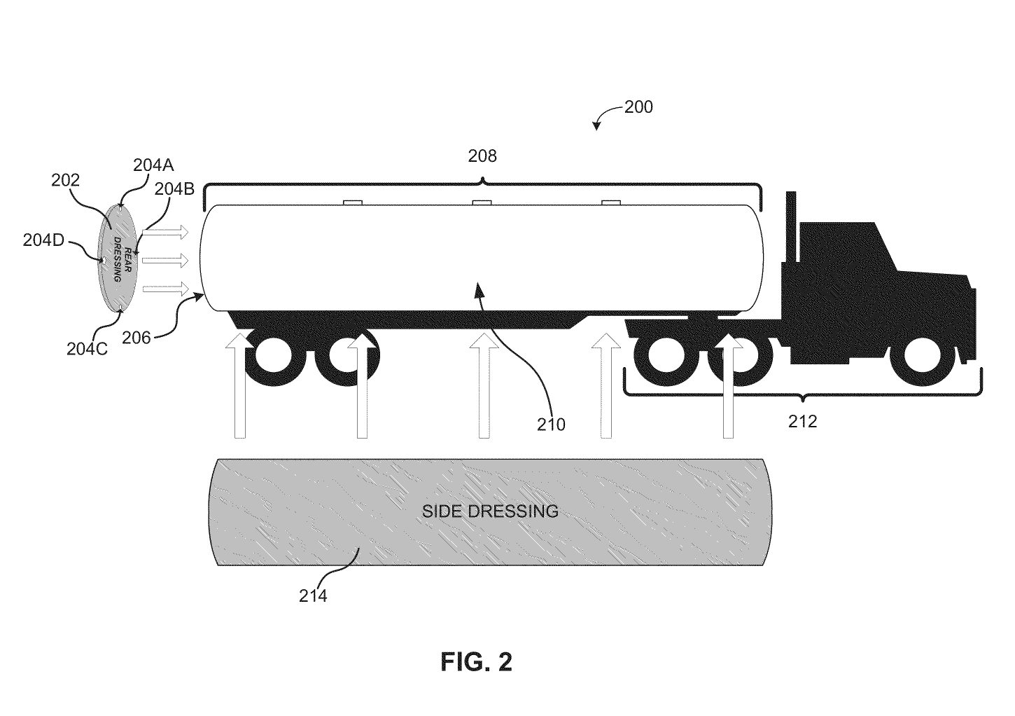

FIG. 2 is a diagram illustrating how an exemplary advertising apparatus may be coupled to a vehicle in accordance with some embodiments. In particular, a truck 200 (hereafter, “vehicle 200”) comprises a tractor 212 and a tanker trailer 208. As illustrated, a side dressing 214 is applied to a side section 210 (a portion or all) of the tanker trailer 208 such that it covers the side section 210. Where the advertising apparatus is to cause the tanker trailer 208 to resemble an aluminum beverage can, the side dressing 214 may be configured to depict (by way of two-dimension and/or three-dimensional features) the side of the aluminum beverage can as it appears on the product packaging. As described herein, the side dressing 210 may be coupled to the tanker trailer 208 by a number of means, including fasteners (e.g., magnets, Velcro®, straps, etc.) that can cause the side dressing 210 to remain coupled to the trailer 208 when the vehicle 200 is in motion.

Similarly, a rear dressing 202 is applied to a rear section 206 of the tanker trailer 208 such that it covers the rear section 206. Again, where the advertising apparatus is to cause the tanker trailer 208 to resemble an aluminum beverage can, the rear dressing 202 may be configured to depict (by way of two-dimension and/or three-dimensional features) the top side or the bottom side of the aluminum beverage can as it appears on the product packaging. The rear dressing 202 may utilize fasteners 204a-204d configured to couple the rear dressing to the rear section 206 of the tanker trailer 208.

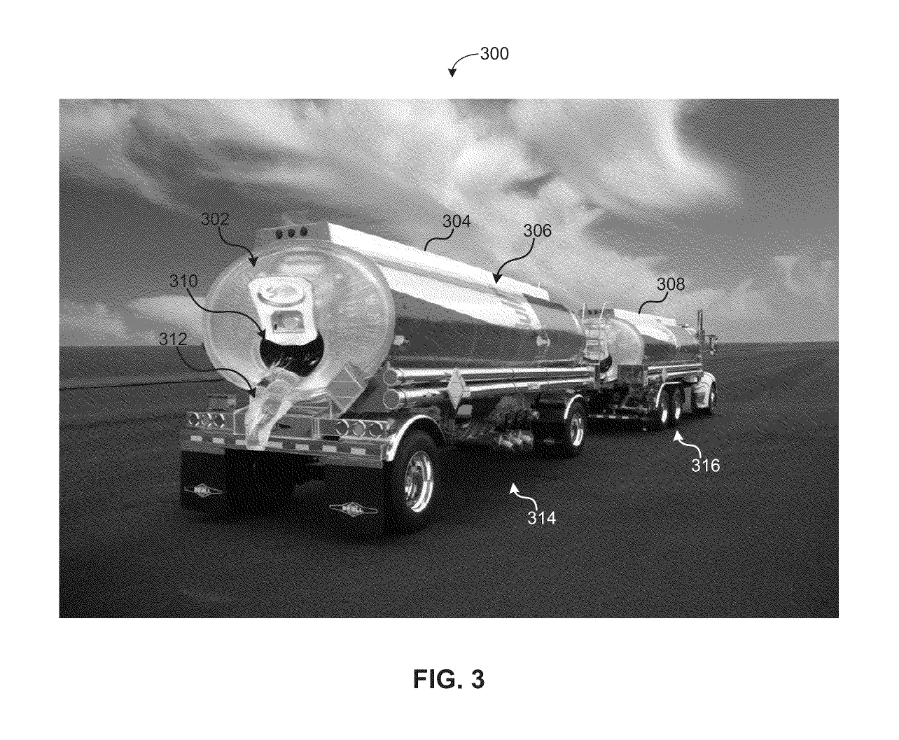

FIG. 3 depicts an exemplary advertising apparatus that causes a vehicle to resemble an aluminum beverage can in accordance with some embodiments. In particular, a truck 300 (hereafter, “vehicle 300”) comprising a tanker truck 316 and tanker trailer 314 respectively having tanker portions 108 and 104. As shown for the tanker trailer 314, its tanker portion 304 is equipped with an advertising apparatus having a rear dressing 302 and a side dressing 306 that causes the tanker portion 304 to resemble an aluminum beverage can. As further shown, the rear dressing 302 (which may be coupled to the tanker portion 304 as described with respect to FIG. 2) depicts a top side of an aluminum beverage can after a stay-on-tab mechanism disposed on the top side has created an opening 310 in the aluminum beverage can. The rear dressing 302 further depicts product content 312 (e.g., soda) pouring from the opening 310. For some embodiments, the rear dressing 302 may comprise three-dimensional structural features, possibly in conjunction with two-dimensional depictions, that enable the rear dressing 302 to cause the rear section of the tanker portion 304 to resemble the top side of an aluminum beverage can. For example, the product content 312 may comprise a relief or a three-dimensional structural projection that causes the product content 312 to further appear as if it is pouring out from the opening 310. For some embodiments, the product content 312 may implemented as an extension (e.g., fabric-based) that extends from the rear dressing 302 and covers sections of the tanker trailer 314 such that the product content 312 appears to be pouring out of the opening 310 and off of the tanker trailer 314.

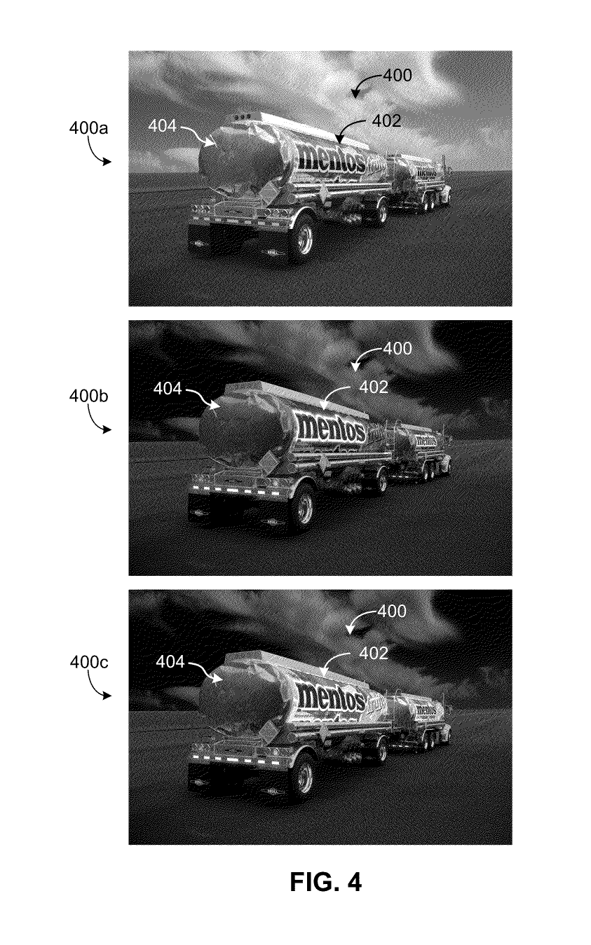

FIG. 4 depicts an exemplary advertising apparatus that causes a vehicle to resemble a roll of candy in accordance with some embodiments. In particular, FIG. 4 presents a truck 400 (hereafter, “vehicle 400”) equipped with an advertising apparatus comprising an illumination system that causes portions of the advertising apparatus to be illuminated. Depiction 400a presents the vehicle 400 while the advertising apparatus, comprising a rear dressing 404 and a side dressing 402, is not illuminated. Depiction 400b presents the vehicle 400 when a portion of side dressing 402 (i.e., the lettering), which covers a section of the tanker portion of the truck, is illuminated. Depiction 400c presents the vehicle 400 when the entirety of side dressing 402, which covers a section of the tanker portion of the truck, is illuminated. For some embodiments, the side dressing 402 may comprise an electroluminescent panel that facilitates illumination of some or all of the side dressing 402. Those skilled in the art will appreciate that for various embodiments, the dressing may comprise different illumination mechanisms including, for example, light emitting diodes (LEDs), reflectors, and fluorescent lights. Depending on the embodiment, illumination control for an advertising apparatus may be according to the lighting control of the vehicle (e.g., coupled to the lighting control of the trailer) and/or may be controlled by a control system independent of the control systems of the vehicle.

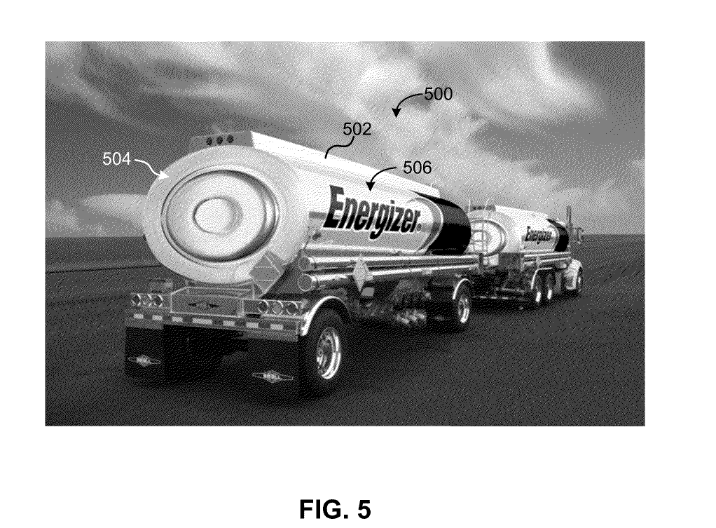

FIG. 5 depicts an exemplary advertising apparatus that causes a vehicle to resemble a battery in accordance with some embodiments. In particular, FIG. 5 presents a truck 500 (hereafter, “vehicle 500”) equipped with an advertising apparatus having a rear dressing 504 and a side dressing 504 coupled to the vehicle 500 to cause its tanker portion 502 to resemble an battery. As shown, the rear dressing 504 may be configured to cause the rear section of the tanker portion 502 to resemble the top-side or bottom-side of a battery commonly available for consumer purchase (e.g., AA-size, AAA-size, AAAA-size, C-size, or D-size battery), and the side dressing 504 may be configured to cause some or all of the exterior surface area of the tanker portion 502 to resemble the side of a battery.

Various embodiments are described herein as examples. It will be apparent to those skilled in the art that various modifications may be made and other embodiments can be used without departing from the broader scope of the invention(s) presented herein. These and other variations upon the exemplary embodiments are intended to be covered by the present invention(s).

1. An advertising apparatus for a vehicle, the advertising apparatus comprising:
one or more flexible side dressings configured to cover at least a majority left-side portion and a majority right-side portion of an exterior body of a vehicle, each of the one or more flexible side dressings having an image presented thereon for causing the left-side portion and right-side portion of the vehicle to physically resemble a consumer product when the one or more flexible side dressings are coupled to the vehicle;
one or more rear dressings configured to cover at least a majority rear portion of the exterior body of the vehicle, the one or more rear dressings having one or more three-dimensional projections thereon, the one or more three-dimensional projections of the one or more rear dressings being shaped to resemble one or more three-dimensional projections of the consumer product, the one or more rear dressings for causing the rear portion of the vehicle to physically resemble the consumer product when the one or more rear dressings are coupled to the vehicle;
one or more side fasteners configured to couple the one or more flexible side dressings to the vehicle such that the one or more flexible side dressings cover the majority left-side portion and the majority right-side portion of the exterior body of the vehicle; and
one or more rear fasteners configured to couple the one or more rear dressings to the vehicle such that the one or more rear dressings cover the majority rear portion of the exterior body of the vehicle.

2. (canceled)

3. The advertising apparatus of claim 1, wherein at least one of the one or more side fasteners or the one or more rear fasteners comprises a magnet, an adhesive, a hook-and-loop fastener, a clip, a strap, a rope, or a button.

4. The advertising apparatus of claim 1, wherein the consumer product comprises consumer product packaging.

5. The advertising apparatus of claim 4, wherein the consumer product packaging is a can, a bottle, a tube, a box, a bag, or a wrapper.

6. The advertising apparatus of claim 4, wherein the consumer product packaging is a can, and the one or more rear dressings includes one or more particular three-dimensional projections configured to cause the rear portion of the exterior body of the vehicle to appear to include a pull-tab opening mechanism of the can.

7. (canceled)

8. The advertising apparatus of claim 4, wherein the product packaging is a tube, and the one or more rear dressings includes one or more particular three-dimensional projections configured to cause the rear portion of the exterior body of the vehicle to appear to include a screw-on cap or a pop-up cap of the tube.

9. The advertising apparatus of claim 4, wherein the one or more rear dressings are configured to cause the rear portion of the exterior body of the vehicle to appear to have an opening and product content visible through the opening.

10. The advertising apparatus of claim 9, wherein the one or more rear dressings includes one or more particular three-dimensional projections configured to cause the rear portion of the exterior body of the vehicle to appear to have the product content spilling from the opening.

11. The advertising apparatus of claim 1, wherein the vehicle is a trailer, a truck, a tanker or a rail-based vehicle.

12. (canceled)

13. The advertising apparatus of claim 1, wherein at least one of the one or more flexible side dressings or the one or more rear dressings comprises an electroluminescent panel.

14. (canceled)

15. The advertising apparatus of claim 1, further comprising an electronic lighting system configured to illuminate at least a portion of at least one of the one or more flexible side dressings or the one or more rear dressings.

16. The advertising apparatus of claim 1, wherein at least one of the one or more flexible side dressings or the one or more rear dressings comprises a plastic overlay, a fabric sleeve, or a metal attachment.

17. A method of advertising using a vehicle, comprising:
using a left-side fastener to attach one or more flexible left-side dressings to cover at least a majority left-side portion of an exterior body of the vehicle, each of the one or more flexible left-side dressings having a left-side image presented thereon for causing the left-side portion of the exterior body of the vehicle to physically resemble a left-side portion of a consumer product when the flexible left-side dressing is coupled to the vehicle;
using a right-side fastener to attach one or more flexible right-side dressings to cover at least a majority right-side portion of an exterior body of the vehicle, each of the one or more flexible right-side dressings having a right-side image presented thereon for causing the right-side portion of the exterior body of the vehicle to physically resemble a right-side portion of a consumer product when the flexible right-side dressing is coupled to the vehicle;
using a rear fastener to attach one or more rear dressings to cover at least a majority rear part of a rear portion of the exterior body of the vehicle, the one or more rear dressings having one or more three-dimensional projections thereon, the one or more three-dimensional projections of the one or more rear dressings being shaped to resemble one or more three-dimensional projections of the consumer product, the one or more rear dressings for causing the rear portion of the vehicle to physically resemble the consumer product when the one or more rear dressings are coupled to the vehicle.

18. The method of claim 17, wherein the vehicle is a trailer, a truck, a tanker or a rail-based vehicle.

19. The method of claim 17, wherein the consumer product comprises consumer product packaging.

20. An advertising apparatus for a vehicle, comprising:
flexible first means for covering at least a majority left-side portion and a majority right-side portion of an exterior body of a vehicle, the flexible first means having one or more images presented thereon for causing the left-side portion and right-side portion of the vehicle to physically resemble a consumer product when the flexible first means is coupled to the vehicle;
three-dimensional second means for covering at least a majority rear portion of the exterior body of the vehicle, the three-dimensional second means having one or more three-dimensional projections thereon, the one or more three-dimensional projections of the three-dimensional second means being shaped to resemble one or more three-dimensional projections of the consumer product, the three-dimensional second means for causing the rear portion of the vehicle to physically resemble the consumer product when the second means is coupled to the vehicle;
third means for coupling the flexible first means to the vehicle such that the flexible first means covers the majority left-side portion and the majority right-side portion of the exterior body of the vehicle; and
fourth means for coupling the three-dimensional second means to the vehicle such that the three-dimensional second means covers the majority rear portion of the exterior body of the vehicle.

21. The advertising apparatus of claim 1, wherein the vehicle is a tanker or tanker trailer and the consumer product is a battery.

22. The advertising apparatus of claim 1, wherein the vehicle is a tanker or tanker trailer and the consumer product is a soda-pop can.

23. The advertising apparatus of claim 1, wherein the vehicle is a tanker or tanker trailer and the consumer product is a candy bar.
